(19) United States
(12) Patent Application Publication
(10) Pub. No.: US 2006/0135361 A1
(43) Pub. Date: Jun. 22, 2006

(54) Markable material

(76) Inventors: David P. Markel, Albany, OR (US); Marshall Field, Corvallis, OR (US); Michael J. Day, Philomath, OR (US); Qin Liu, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/021,575

(22) Filed: Dec. 22, 2004

(51) Int. Cl. B41M 5/24

(52) U.S. Cl. 503/200

(57) ABSTRACT

A markable material includes a base matrix material, a thermally activated marking material, and at least one colorant.

### BACKGROUND

Data storage media provide a convenient way to store large amounts of data in stable and mobile format. For example, optical discs, such as compact discs or other discs allow a user to store relatively large amounts of data in single place. Data on such discs often includes entertainment, such as music and/or images as well as other types of data. In the past, consumer devices were read only. In other words, devices were configured to read the data stored on such devices and the devices were not configured to store data thereon. Data was frequently placed on the disc by way of a large commercial machine that burned the data onto the disc. In order to identify the contents of the disc, commercial labels were frequently printed onto the disc by way of screen printing or other similar methods.

Recent efforts have been directed to providing disc burning or writing capabilities to consumers. Such efforts include the use of drives that are configured to burn recordable compact discs, rewritable compacts discs, recordable digital video discs, and/or rewritable digital video discs to name a few. These drives provide a convenient way for users to record relatively large amounts of data that may then be easily transferred or used in other devices.

The data storage mediums, such as compact discs or other such mediums, frequently have two sides: a data side and a label side. The data side contains data that is burned into the medium. The label side is frequently a background on which the user hand writes information thereon to identify the disc. Accordingly, it may be difficult and relatively time consuming to provide high-quality hand written labels.

### SUMMARY

A markable material includes a base matrix material, a thermally activated marking material, and at least one colorant.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 illustrates a schematic view of a media processing system according to one exemplary embodiment.

FIG. 2 is a flowchart illustrating a method of forming a color markable substrate according to one exemplary embodiment.

FIGS. 3-1 and 3-2 illustrate a preliminary evaluation of several colored markable substrates formed with the addition of several exemplary additives combined with a base matrix material and a thermally markable material applied to a glass slide according to one exemplary embodiment.

FIG. 4 illustrates results of an evaluation of colored markable substrates formed on disks with the addition of several exemplary additives as combined with a base matrix material and a thermally markable material.

FIG. 5 illustrates the results of colored markable substrates of FIG. 4 after the substrates were subjected to a fade treatment according to one exemplary embodiment.

FIG. 6 illustrates results of an evaluation of colored markable substrates applied to discs formed with the addition of several exemplary additives as combined with a base matrix material and a thermally markable material.

FIGS. 7 and 8 illustrate a comparison of the characteristics of markable substrates colored with exemplary colorants and a default markable substrate according to one exemplary embodiment. FIG. 9 illustrates a comparison of the chromaticity of a default markable material compared to a colored markable substrate.

Throughout the drawings, identical reference numbers designate similar, but not necessarily identical, elements.

### DETAILED DESCRIPTION

The present compositions and methods provide for the formation of a colorable and/or surface treated markable substrate. In particular, several dyes may be added to a default marking material. The default marking material described herein includes a base matrix material and a thermally activated marking material.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Schematic View of a Media System

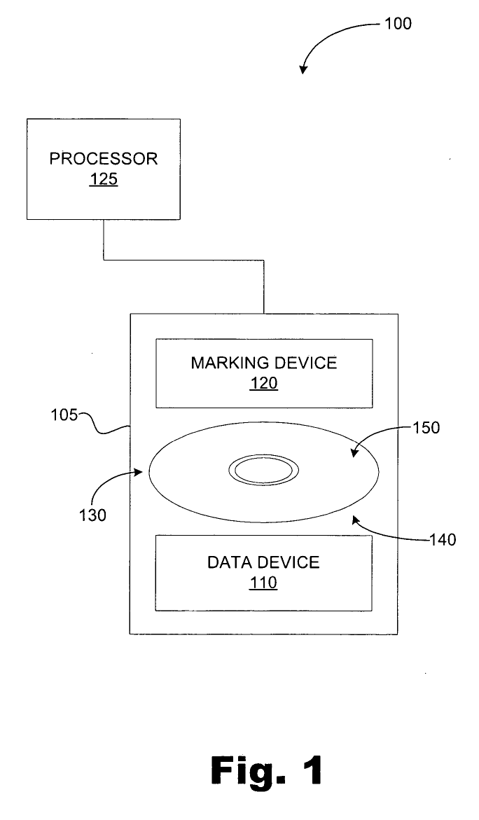

FIG. 1 illustrates a schematic view of a media processing system (100). As will be described in more detail below, the media processing system (100) allows a user, among other things, to insert a markable data storage medium (markable disc) into the system to have data stored on the data storage medium and to have a label printed thereon. The label printed thereon may include a background selected from a number of colors.

The media processing system shown includes a housing (105) that houses a data device (110) and a marking device (120) coupled to a processor (125). The operation of both the data device (110) and the marking device (120) may be controlled by the processor (125). The media processing system (100) also includes hardware for placing a markable data storage medium (markable disc) (130) in position to be read by the data device (110) and/or marked by the marking device (120). The operation of the hardware may also be controlled by the processor (125).

The processor (125) shown is separate from the media processing system (125), according to one exemplary embodiment. Exemplary processors (125) may include, without limitation, a computer or other such device. The processor (125) may have software or other drivers residing thereon configured to control the operation of the data device and the marking device to selectively read and/or write data to the data storage medium (130). Those of skill in the art will understand that any suitable processor may be used, including a processor configured to reside on the media processing system.

As introduced, the data device (110) and the marking device (120) are each configured to interact with a markable data storage medium (130). In particular, the exemplary markable disc (130) includes first and second opposing sides (140, 150). The first side (140) has a data surface formed thereon that is configured to store data while the second side (150) has a markable surface formed thereon.

With respect to the first side (140), the data device (110) may be configured to read data stored on the data device (110) and/or to store data on the markable disc (130). The output of the data device (110) may be processed by the processor (125) and output to a user in the form of sound, image, and/or data. In the case of reading stored data, the output of the data device (110) is sent to the processor (125). Exemplary markable discs include, without limitation recordable compact discs (CD-R), rewritable compact discs (CD-RW), recordable digital video discs (DVD-R), and/or rewritable digital video disks (DVD-RW) or other types of data storage media.

In addition, the marking device (120) may be configured to selectively mark the surface of the second side (150), the marking device (120) may thus be configured to form a ‘label’ on the second side.

Colorants and/or finishing agents may be added to the default marking material used to form the markable surface to cause a change in background color and/or finishing effects. These additives will be discussed in more detail below. Accordingly, the media processing system (100) allows a user, among other things, to store data on the markable disc and to have a label printed thereon.

In a preferred embodiment, the marking material of the present invention is comprised of approximately 20 to 30% leuco dye, approximately 1 to 3% near-IR absorbing dye and approximately 10 to 20% developer.

Method of Forming Background Material

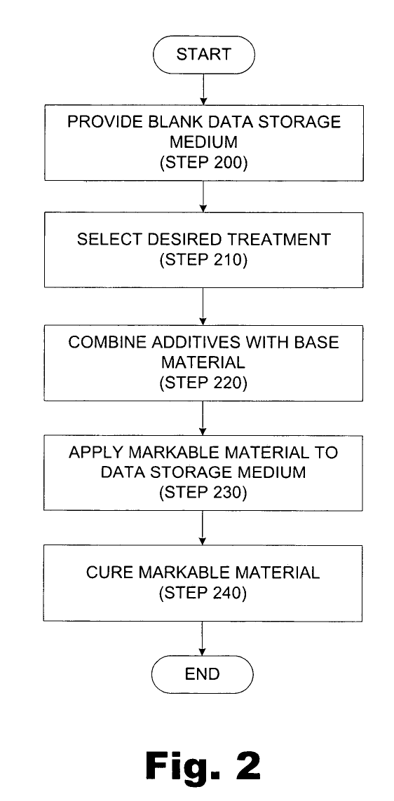

FIG. 2 illustrates a method of forming a markable data storage medium according to one exemplary embodiment. The method begins by providing a blank data storage medium (step 200). Exemplary blank data storage mediums include optical data storage media that have a data medium formed on one side of the medium and a label side on the opposing side.

The desired background color and/or surface treatments are then selected (step 210). Any different number of color combinations or treatments may be selected. Additives are then added to a base material to form a colored markable material that has the desired properties (step 220). Several exemplary additives and their resulting properties are described in more detail below. Thereafter, the marking material is applied to the label side of the blank storage medium (step 230). The colored markable material is then cured (step 240) and the blank storage medium is ready to have data written thereto and to have a label formed thereon.

### Exemplary Formulations

The substrates and results discussed below include default material that includes a base matrix material combined with a thermally markable material. Several exemplary dyes and/or surface treatments may be combined with the default marking material. The results for several of these combinations are discussed below.

FIGS. 3-1 and 3-2 illustrate a preliminary evaluation of several colored markable substrates formed with the addition of several exemplary additives as combined with a base matrix material and a thermally markable material. A suitable thermally markable material includes a base matrix material, as an example, 50% CDG000 resin, 6% UV photoinitiator, 27% leuco dye, 1.5% near-IR absorbing dye, 12% developer, and various additives for stabilizing and printing. For ease of reference, this formulation will be referred to as the first default marking material.

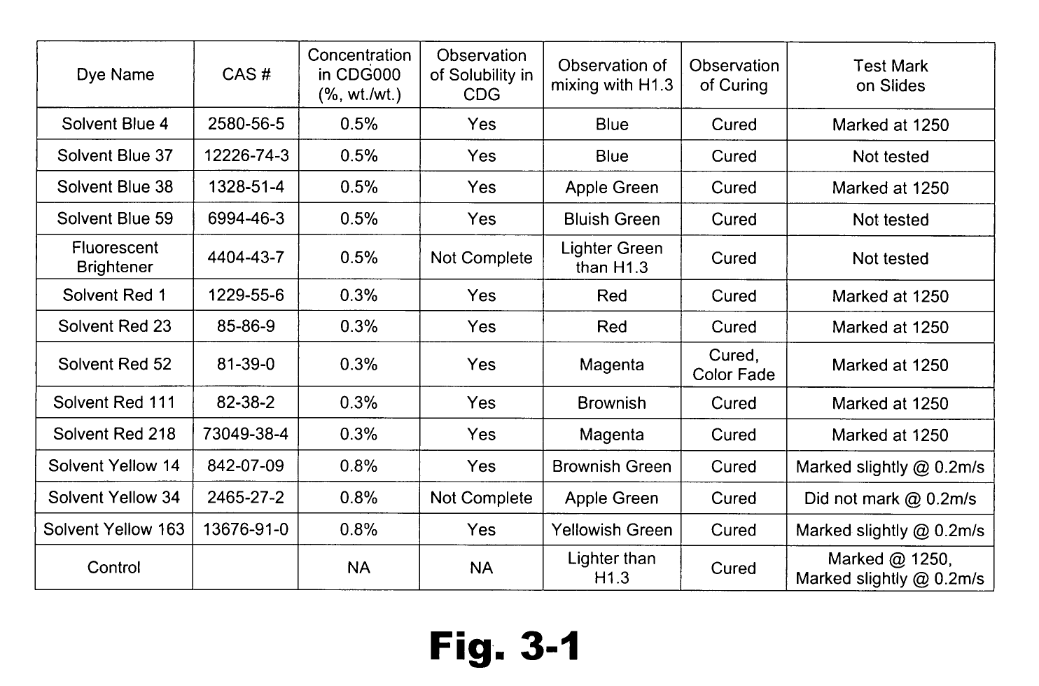

The thermally markable material is configured to be marked according to a marking operation. One such operation may include, without limitation, focusing a 780 nm laser on a label surface using an integral photodiode. An information file, label, picture, et cetera, is formatted using proprietary software. This formatted information is used to selectively activate the laser as the disc is rotated, proceeding from the inner diameter to the outer. Black marks appear as the absorber in thermally markable material as the thermally markable material preferentially absorbs the 780 nm radiation and transmits the heat to a leuco dye and developer. As shown in FIG. 3-1, several solvent dyes, which are defined here as dyes soluble in an organic solvent and usually introduced in the form of a solution in an organic solvent, were soluble in CDG000 (Norcote International). These solvent dyes displayed acceptable performance characteristics.

These solvent dyes used here include, without limitation, Solvent Blue 4, Solvent Blue 37, Solvent Blue 38, Solvent Blue 59, Fluorescent Brightener, Red Solvent 1, Red Solvent 23, Red Solvent 52, Solvent Red 218, Solvent Red 23, Solvent Red 52, Solvent Red 111, Solvent Red 218, Solvent Yellow 14, Solvent Yellow 34, and Solvent Yellow 163. The relative weights of the solvent dyes combined with the base matrix are listed in FIG. 3-1. Further, the solubility of these dyes was then observed as well as the resulting colors observed when mixing the dyes with the first default material.

The thermally markable material and dye mixtures were prepared and spread on glass slides and cured. Suitable curing conditions may include passing the sample below a discharge lamp at the rate of about 7 meter/minute. The conveyor belt moves the samples under a 300 watt/inch Hg discharge lamp. The lamp is rich in UV wavelengths. The UV is absorbed by the photoinitiator in the thermally markable material which crosslinks the CDG000 and forms a smooth, hard film. The application of the dyed markable substrates on glass slide may be referred to as screen tests. The use of a curing operation may help to determine the presence of undesirable effects, such as premature development of the dye.

Each of the slides discussed with reference to FIGS. 3-1 was then test marked according to the method previously described. The results of the test marks are illustrated under “Test Mark on Slides” as show in FIG. 3-1. Matte surface treatments were also prepared as shown in a similar manner to that described with reference to FIG. 3-1. The summary of the matte surface treatment screen tests are illustrated in FIG. 3-2. These screen tests on glass slides indicated several candidates that are compatible with the first default material (then default in formulation) in blue, red (magenta), yellow, and matte finishing agents.

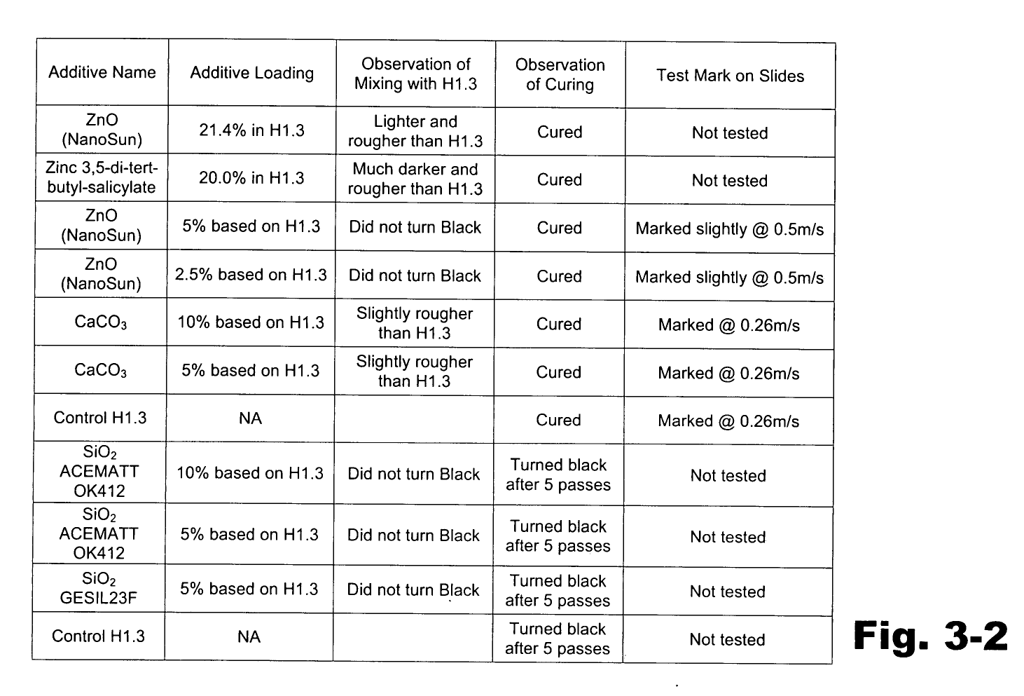

Based on these screen experiments, selected solvent dyes were added into the first default material and applied to discs for further testing. FIG. 4 illustrates the results of the disc tests. The discs were tested for marking speed and 24 hour fade as compared with the first default material. Color evaluation was performed by measuring the chromaticity of the substrate.

Tests were then performed on each of the discs to compare the characteristics of the dyed markable substrate to a standard or the first default material substrate. These discs were coated with various red and blue colorants in the first default material. Each disc was marked according to the previously described method. The marking operations described includes the deposition of 1250 tracks per inch (TPI), in which a track describes the width of a single marking pass. Accordingly, a 1250 TPI marking process includes forming 1250 tracks per each inch of width. The change in optical density (ΔOD) provides an indication of the contrast between the unmarked dyed markable substrate and the marked markable substrate. The linear velocities at which the standardized total optical density (OD) and the change in optical density (ΔOD) achieved on each disc were then noted. The linear velocities corresponding to a total optical density (OD) greater than or equal to 0.95 and a change in optical density (ΔOD) of greater than or equal to 0.45 were included in the Figures.

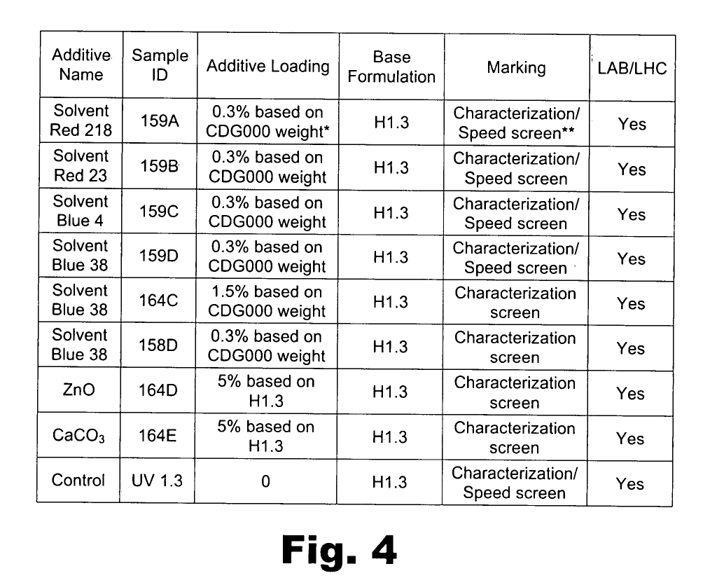

The discs were then subjected to a one-day fade chamber treatment. The marked substrate was then subjected to a fading process in a fade chamber for approximately 24 hours wherein the temperature was maintained at 35 degrees Celsius and the relative humidity at 80%. The results of these tests are summarized in FIG. 5. In particular, the highest linear velocity corresponding to a total optical density of 0.95 (OD before and after fade treatment) or greater as well as the linear velocities in achieving changes in optical densities greater than or equal to 0.45 are included. The results of the marking operations both before and after the fade treatment were then compared, as indicated by the label “% change in OD (before and after fade)” and “% CHANGE IN ΔOD (before and after fade).”

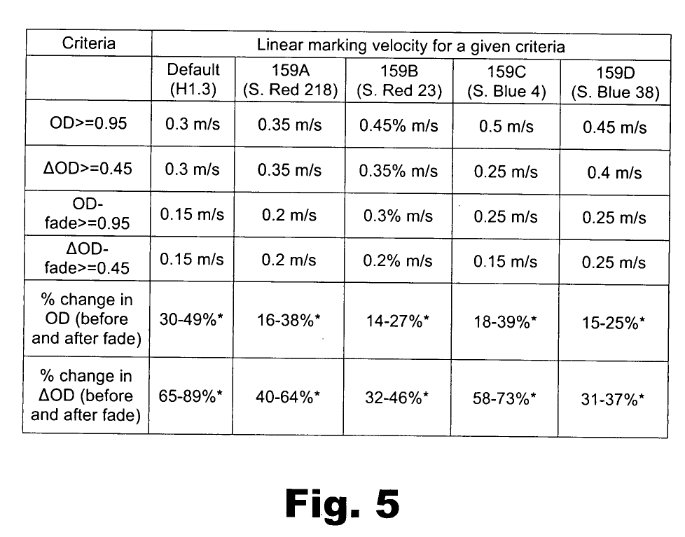

As seen in FIG. 5, the discs with dyes or colorants had higher or similar marking speeds at a given OD or ΔOD and similar or smaller percent of change before and after fade treatment as compared with the first default material. Thus, the addition of small amounts of the colorants did not seem to reduce the marking speed or fading resistance. Similar conclusions can be drawn with higher concentrations of Solvent Blue 38 (to evaluate color range) as shown in FIG. 6.

As with dyes, it is also possible to obtain good results in marking speed and fading resistance with pigments such as, without limitation, ZnO, SiO₂, and CaCO₃. FIG. 6 shows some marking speed and fading resistance data obtained with 5% of ZnO and CaC0O₃. Such metal oxides and carbonates can also function as a surface treatment when added to a thermally markable material.

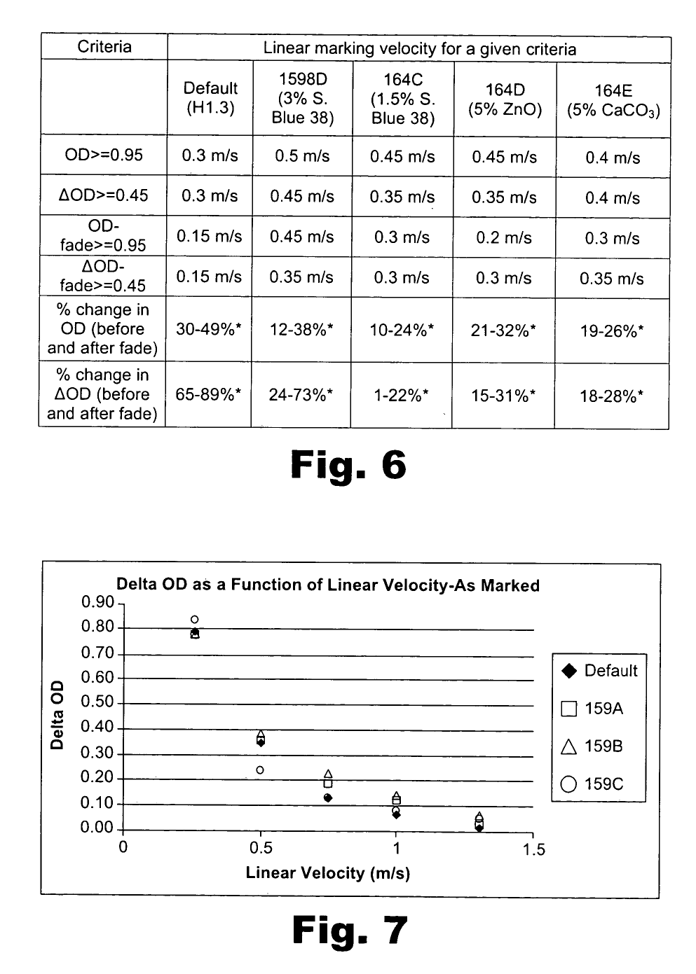

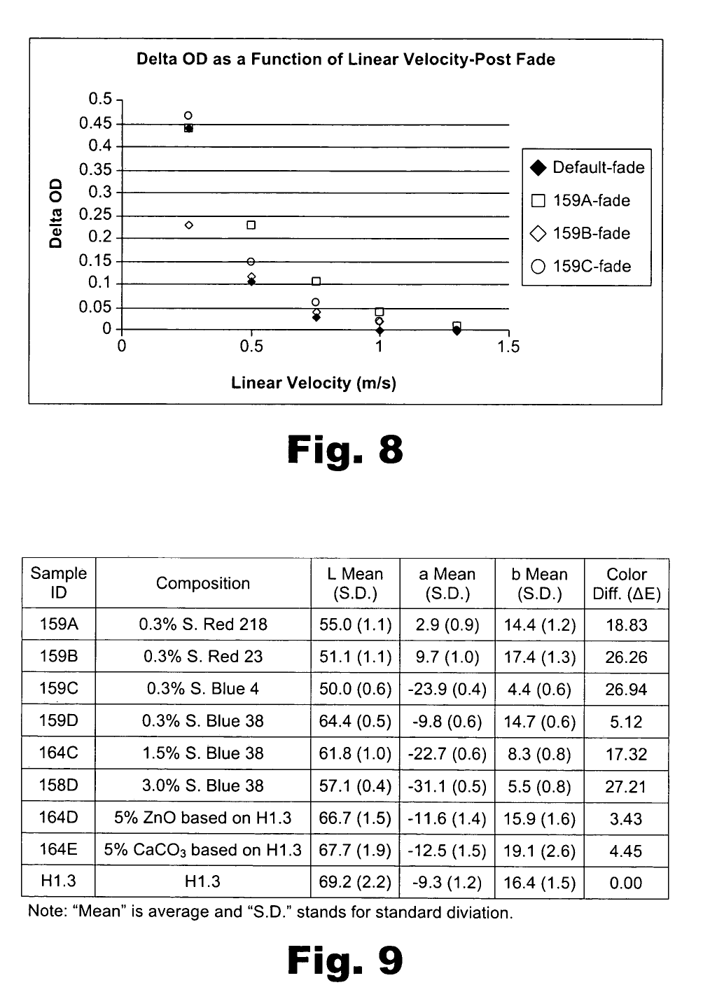

FIGS. 7 and 8 illustrate a comparison of the characteristics of markable substrates colored with Solvent Red 218, Solvent Red 23, and Solvent Blue 4 compared to the default, such as the first default material, which were processed according to the process discussed above. In particular, the mean values of ΔOD are plotted against linear marking velocity before the fade treatment (FIG. 7) and after the fade treatment (FIG. 8). At a 95% confidence interval, there is no statistically significant difference in ΔOD between the colored discs and the control for linear velocities of 0.26, 0.5, 0.75, 1 and 1.3 m/s before and after the fade treatment.

FIG. 9 illustrates the results of a comparison of the color difference between disks with color or matte finishing agents and default. The color difference was evaluated by measuring the chromaticity and calculating ΔE. ΔE is the linear difference between two colors in a three dimensional color space as defined in the published measurement Standard CIE(1964). The larger ΔE, the greater the difference between the two colors. ΔE is defined as:
[(ΔL)²+(Δa)²+(Δb)²]^{1/2} Equation 1
where ΔL is the change in lightness or luminance, Δa is the change in the red/green coordinate, and Δb is the change in the yellow/blue coordinate between two colors. Δa=(a₁-a₂) for color 1 and color 2.

From this data, one observes that for a given loading, Solvent Red 23 may be more effective than Solvent Red 218, and Solvent Blue 4 may be more effective than Solvent Blue 38 in changing the background color. As expected, higher loading of color additive brought more color change with Solvent Blue 38. Visually, the color differences between 159A, 159B, 159C, 158D, 164C and the first default material are distinct while that of 159D is not. For the matte finishing additives, 5% loading did not seem to affect the whiteness (L) significantly. Visual observation did not indicate significant surface modification effect either. Higher loading of the matte finishing agents may be helpful but will be limited by the already high viscosity of the media and the need to increase marking speed and thus higher loading of other ingredient.

Accordingly, FIGS. 3 through 9 illustrate several exemplary colorants or dyes and surface treatments that may be used to control the color and/or surface characteristics of a markable substrate used to label media, such as compact discs, digital video discs, etc. The dyes discussed above were combined with the first default material and included various red, yellow, and blue dyes. Other suitable thermally responsive marking materials may be used. One such additional thermally responsive marking material will now be discussed.

In conclusion, the present compositions and methods provide for the formation of a colorable and/or surface treated markable substrate. In particular, several dyes may be added to a default marking material. The default marking material described includes a base matrix material and a thermally activated marking material.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. A markable material, comprising:
a base matrix material;
a thermally activated marking material; and
at least one colorant.

2. The material of claim 1, wherein said base matrix material comprises a clear UV curable resin.

3. The material of claim 2, wherein said clear UV curable resin comprises stabilized acrylate monomers and oligomers and a solubilized photoinitiator.

4. The markable material of claim 1, wherein said thermally activated marking material comprises approximately 20 to 30% leuco dye, approximately 1 to 3% near-IR absorbing dye, and approximately 10 to 20% developer.

5. The markable material of claim 1, wherein said colorant comprises a solvent dye.

6. The markable material of claim 5, wherein said solvent dye is selected from the group consisting of Solvent Blue 4, Solvent Blue 37, Solvent Blue 38, Solvent Blue 59, Solvent Red 1, Solvent Red 23, Solvent Red 52, Solvent Red 218, Solvent Red 111, Solvent Yellow 15, Solvent Yellow 34, and Solvent Yellow 163.

7. The markable material of claim 1, wherein said colorant comprises a pigment.

8. The markable material of claim 7, wherein said pigment comprises a member of is selected from the group consisting of ZnO, SiO₂ and CaCO₃.

9. The markable material of claim 1, wherein said colorant comprises Fluorescent Brightener.

10. A method of forming a thermally markable material, comprising:
combining an additive with a thermally markable material;
applying said thermally markable material to a substrate; and
curing said thermally markable material.

11. The method of claim 10, wherein combining said additive comprises adding a colorant to said thermally markable material.

12. The method of claim 10, wherein combining said additive comprises adding a surface treatment to said thermally markable material.

13. The method of claim 12, wherein adding the surface treatment comprises adding a metal oxide or carbonate to said thermally markable material.

14. The method of claim 10, wherein applying said thermally markable material to a substrate comprises applying said thermally markable material to a data storage medium.

15. The method of claim 14, wherein applying said thermally markable material to a substrate comprises applying said thermally markable material to a compact disc.

16. The method of claim 14, wherein applying said thermally markable material to a substrate comprises applying said thermally markable material to a digital video disc.

17. A composition, comprising:
markable means for selectively marking a substrate;
coloring means for coloring said markable means.

18. The thermally markable material of claim 17, further comprising surface treatment means for controlling the surface of said substrate.
